(19) United States
(12) Patent Application Publication
(10) Pub. No.: US 2025/0273767 A1
(43) Pub. Date: Aug. 28, 2025

(54) BATTERY FIRE EXTINGUISHING DEVICE

(71) Applicant: KOREA MARITIME UNIVERSITY INDUSTRY-ACADEMIC COOPERATION FOUNDATION, Busan (KR)

(72) Inventors: Sung Hwan YOON, Busan (KR); Ju Won PARK, Busan (KR)

(21) Appl. No.: 19/208,209

(22) Filed: May 14, 2025

Related U.S. Application Data
(63) Continuation of application No. PCT/KR2023/018309, filed on Nov. 14, 2023.

(30) Foreign Application Priority Data
Nov. 14, 2022 (KR) 10-2022-0151457

(51) Int. Cl. H01M 10/657; H01M 10/613; H01M 10/63; H01M 10/643; H01M 50/691

(52) U.S. Cl. CPC H01M 10/657; H01M 10/613; H01M 10/63; H01M 10/643; H01M 50/691

(57) ABSTRACT

The present invention relates to a battery fire extinguishing device which prevents, delays, or extinguishes a battery fire by applying an electric field to a battery when there is a sign of a battery fire. The present invention comprises a battery, and electrode plates formed on both poles of the battery and applying an electric field to the battery when there is a sign of a fire in the battery, and thereby, the present invention prevents, delays, or extinguishes a battery fire by applying an electric field to the battery when there is a sign of a battery fire.

### REFERENCE TO RELATED APPLICATIONS

This is a continuation of International Patent Application PCT/KR2023/018309 filed on Nov. 14, 2023, which designates the United States and claims priority of Korean Patent Application No. 10-2022-0151457 filed on Nov. 14, 2022, the entire contents of which are incorporated herein by reference.

### FIELD OF THE INVENTION

The present disclosure relates generally to a battery fire extinguishing device. More particularly, the present disclosure relates to a device for preventing, delaying, or extinguishing a battery fire by applying an electric field to a battery when there is a sign of a battery fire.

### BACKGROUND OF THE INVENTION

As smartphones and electric vehicles become more widespread, safety issues related to lithium battery (cell, module, or pack) fires are receiving attention.

Due to their inherent characteristics of both flammability and combustion, lithium batteries pose a problem in that when a fire occurs in the battery, it can lead to thermal runaway where a change in temperature accelerates further temperature changes. In particular, even after the fire is extinguished, the battery can re-ignite due to the internal energy, making it very difficult to determine the cause of the fire.

Currently, for battery fire suppression, Korean Patent No. 10-1424704, entitled “Fire Suppression Apparatus for Battery Pack”, discloses an apparatus that extinguishes a fire in a battery pack by injecting an extinguishing agent from an extinguishing agent holding tank into the battery pack when the fire is detected by a fire detection sensor. Korean Patent No. 10-2452775, entitled “Fire Suppression System for Battery with Function of Cool Down Fire Extinguishing Agent” discloses a system that supplies an extinguishing agent and extinguishing gas to quickly extinguish a fire that has occurred in a battery.

Most conventional battery fire extinguishing technologies use fire extinguishing agents. In addition to fire extinguishing agents, suffocating fire covers and immersion methods can be used to extinguish battery fires.

However, the method of using fire extinguishing agents or suffocating fire covers is problematic in that it takes a considerable amount of time to extinguish the fire because the battery needs to be completely burned out due to the risk of re-ignition, and caution must be taken to prevent flames from spreading to surrounding areas.

Furthermore, since lithium-ion batteries are made up of battery cells densely packed in a modular form, it is difficult for general gaseous agents or solid fire extinguishing powders to penetrate into the battery module, and there is a problem in that initial fire extinguishment is nearly impossible even when automatic fire extinguishing equipment operates due to the lack of fire extinguishing agent adaptability.

Additionally, the immersion method is problematic in that not only the battery cell where the fire has occurred but also the battery module itself cannot be reused, causing property damage.

That is, since battery thermal runaway makes it notoriously difficult to extinguish the battery fire, a structure or means for extinguishing the battery fire during the fire growth phase is required.

Accordingly, there is a need to develop a technology that can protect people's lives and safety by equipping safety devices in case a battery fire occurs and finding ways to minimize damage.

### SUMMARY OF THE INVENTION

Accordingly, the present disclosure has been made keeping in mind the above problems occurring in the related art, and an objective of the present disclosure is to provide a battery fire extinguishing device capable of preventing, delaying, or extinguishing thermal runaway by sensing the internal temperature of a battery, thereby minimizing damage to the battery.

In order to accomplish the above objective, the present disclosure provides a battery fire extinguishing device, including: a battery; and a pair of electric field appliers formed on opposite electrodes of the battery and applying an electric field to the battery when there is a sign of a fire in the battery, wherein when there is the sign of the fire in the battery, the battery fire extinguishing device may prevent, delay, or extinguish the fire by applying the electric field to the battery.

In the present disclosure, the pair of electric field appliers may include a pair of electrode plates formed on the opposite electrodes of the battery.

Additionally, the pair of electric field appliers may include: an electrode plate formed on a first electrode of the battery; and an electrode in contact with a second electrode of the battery.

Additionally, when the second electrode of the above battery is a negative electrode, the electrode may be an electrode that is in contact a battery can.

Additionally, the pair of electric field appliers may ground a positive electrode of the battery and apply a positive voltage to a negative electrode of the battery.

Additionally, the pair of electric field appliers may apply a negative voltage to a positive electrode of the battery and ground a negative electrode of the battery.

Additionally, the pair of electric field appliers may ground a negative electrode of the battery and apply a positive voltage to a positive electrode of the battery.

Additionally, the pair of electric field appliers may apply a negative voltage to a negative electrode of the battery and ground a positive electrode of the battery.

Additionally, the battery may be in an upright or inverted state with respect to a ground.

Additionally, the battery fire extinguishing device may further include: a controller that receives a fire sign detection signal of the battery and applies power to the pair of electric field appliers.

Additionally, the controller may convert battery discharge energy into power for the electric field when there is the sign of the fire so that internal charge energy of the battery is consumed to generate the electric field.

Additionally, the battery may installed with a safety venting device facing a ground so that when the safety venting device is activated when there is the sign of the battery fire, an internal electrolyte is released by its own weight through the safety venting device.

Additionally, a dielectric layer may be provided between each of the pair of electric field appliers and the battery.

A battery fire extinguishing device according to the present disclosure can prevent, delay, or extinguish thermal runaway by sensing the internal temperature of a battery, and thus has the effect of quickly extinguishing a fire during the fire growth phase and minimizing damage to the battery.

### BRIEF DESCRIPTION OF THE DRAWINGS

FIG. 1 is a schematic view illustrating a battery fire extinguishing device according to the present disclosure.

FIG. 2 is a schematic view illustrating an experiment for testing the battery fire extinguishing device using an electric field according to the present disclosure.

FIG. 3 is a graph illustrating whether thermal runaway occurs depending on the presence or absence of the electric field in the experiment of FIG. 2.

FIG. 4A is an image illustrating occurrence of thermal runaway depending on the presence or absence of the electric field in the experiment of FIG. 2.

FIG. 4B is an image illustrating suppression of thermal runaway depending on the presence or absence of the electric field in the experiment of FIG. 2.

FIG. 5A is a graph illustrating whether thermal runaway occurs depending on oxidizer inhibition.

FIG. 5B is an image illustrating occurrence of thermal runaway depending on oxidizer inhibition.

FIG. 6 is a schematic view illustrating a battery fire simulation experiment depending on the position of a safety venting device according to the present disclosure.

FIG. 7 is a graph illustrating whether thermal runaway occurs depending on the position of the safety venting device in the experiment of FIG. 6.

FIGS. 8 to 11 are exemplary views each illustrating an electric field applier according to the present disclosure.

FIGS. 12 to 17 are graphs illustrating whether thermal runaway occurs under various conditions of the present disclosure.

### DETAILED DESCRIPTION OF THE INVENTION

Reference will now be made in detail to an exemplary embodiment of the present disclosure with reference to the accompanying drawings. In the following description of the present disclosure, a detailed description of related known configurations or functions may be omitted to avoid obscuring the subject matter of the present disclosure.

Terms used below are defined in view of functions in the disclosure and may thus be changed depending on a user, the intent of an operator, or the custom. Accordingly, the terms should be defined, based on the following overall description of this specification.

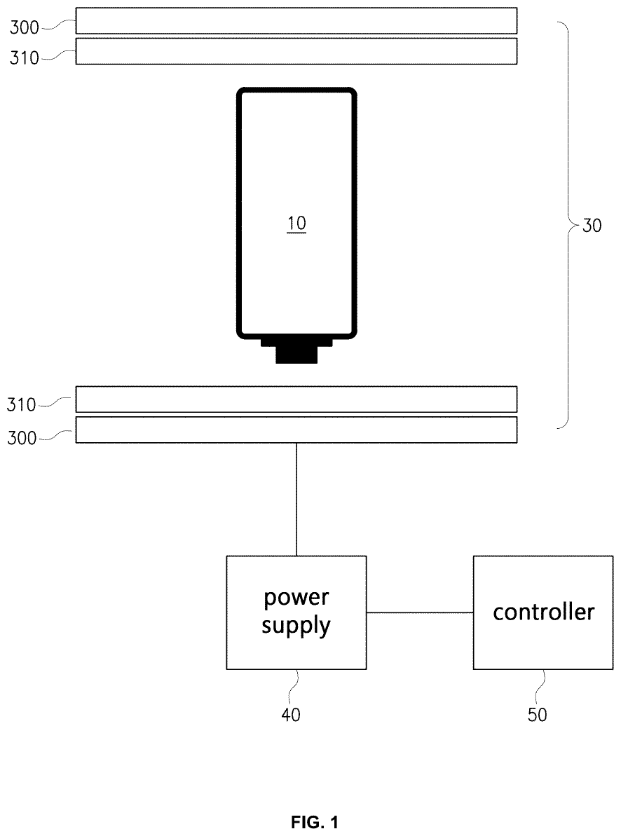

Hereinafter, the configuration of the present disclosure will be described with reference to the accompanying drawings. As illustrated in FIG. 1, a battery fire extinguishing device according to the present disclosure includes a battery 10, a dielectric layer 310, an electric field applier 30, a power supply 40, and a controller 50.

The battery 10 applied to the present disclosure is configured as a battery module including a battery cell, a separator, an electrolyte, and a battery casing. The battery cell is formed in an internal space of the battery casing, and multiple battery cells are stacked to form a battery module (battery pack).

Here, the battery cell may be provided in the form of a cylindrical secondary battery, a pouch-shaped secondary battery, or a prismatic secondary battery. In the embodiment, appropriate modifications and applications are possible depending on the cell type.

That is, in the drawings below, a cylindrical battery is exemplarily illustrated for the purpose of explanation of the present disclosure, but the technical idea of the present disclosure is not limited thereto.

The battery cell is filled with the electrolyte. The electrolyte allows lithium ions in the battery to migrate smoothly between positive and negative electrodes, and plays a role in improving the battery cell characteristics during charging.

Additionally, the separator serves as a passage for lithium ions and plays a role in preventing fires by preventing direct contact between the positive and negative electrodes.

Conventionally, when a fire occurs in the battery 10, a rise in internal temperature of the battery 10 causes the separator to melt, and electric charges present in the positive and negative electrodes of the battery 10 cause an internal short circuit, providing a high-temperature heat source, which triggers thermal runaway. Thermal runaway of the battery 10 is a phenomenon in which the internal temperature rapidly increases and a fire spreads, making it difficult to extinguish the fire and posing a high risk of casualties.

In this regard, the present disclosure has a technical feature in that a pair of electric field appliers 30 are formed on opposite electrodes of the battery 10, respectively, and an electric field is applied to the battery 10 when there is a sign of a battery fire.

According to the present disclosure, by applying the electric field to the battery 10 through the electric field appliers 30, collision of electric charges present in the positive and negative electrodes may be fundamentally blocked, thereby suppressing an internal short circuit.

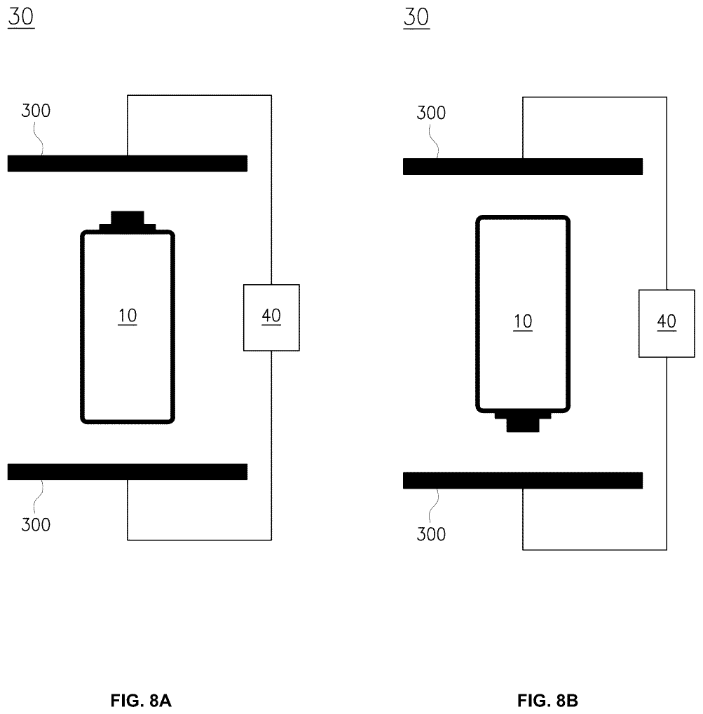

Hereinafter, the electric field applier 30 according to the present disclosure will be described with reference to FIGS. 8 to 11.

In the present disclosure, the electric field applier 30 includes an electrode plate that applies a non-contact electric field or an electrode that directly applies a voltage in a contact manner.

For example, in the present disclosure, as illustrated in the embodiment of FIG. 8, a pair of electric field appliers 30 include a pair of electrode plates 300 facing each other in parallel with the battery 10 interposed therebetween to form a uniform electric field between the electric field appliers 30, and may be made of various alloy/metal materials such as copper, brass, silver, platinum, tungsten, and chromium.

At this time, it is preferable that the opposite electrodes of the battery 10 face the electric field appliers 30, but the present disclosure is not necessarily limited to thereto.

Additionally, unlike the embodiment of FIG. 8, an electric field may be applied inside the battery by directly applying a voltage to an electrode 320 in contact with each of the opposite electrodes of the battery.

It is preferable that the electrode plates are formed in a mesh form.

When the electric field appliers 30 are formed as the electrode plates, as illustrated in FIG. 1, a dielectric layer 310 may be provided between the battery and each of the electrode plates 300.

In the embodiments of FIGS. 8 to 12, a dielectric layer 310 may be provided between each of the electrode plates 300 and the battery 10, but is not illustrated for the purpose of explanation of the present disclosure.

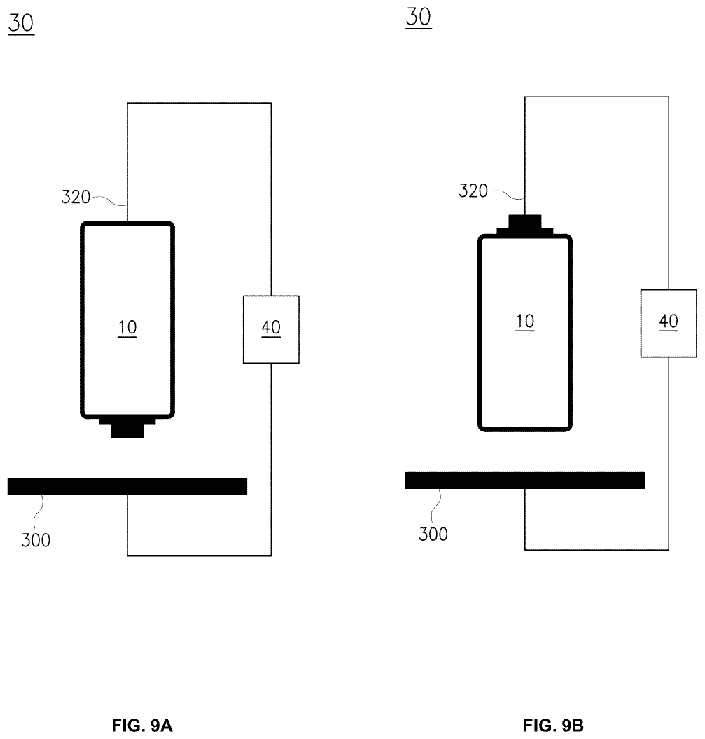

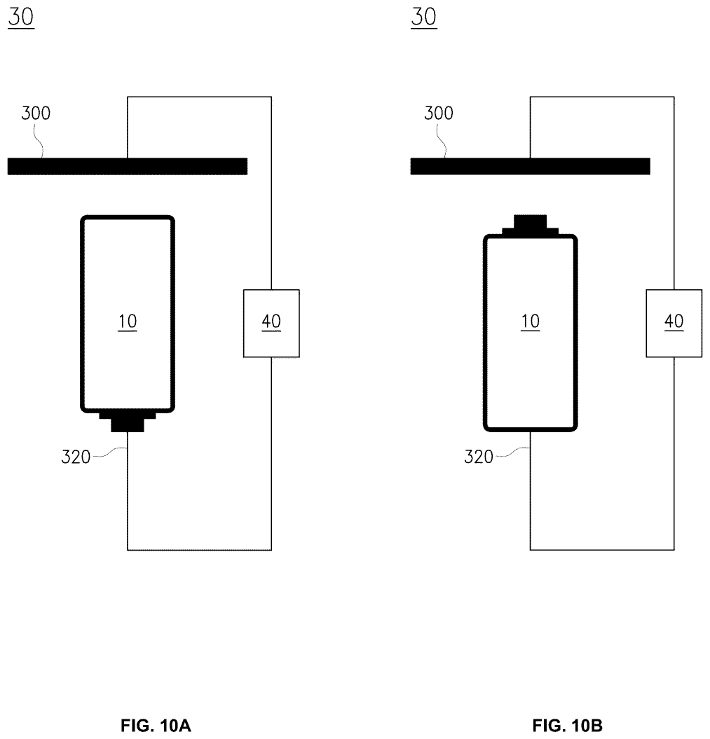

As illustrated in FIGS. 9 and 10, in another embodiment of the present disclosure, the pair electric field appliers may include an electrode plate 300 formed on a first electrode of a battery 10 and an electrode 320 in contact with a second electrode of the battery 10.

The electrode plate is spaced apart from the battery, and the electrode is in contact with the battery.

The arrangement of the electrode plate and electrode includes a case where the electrode plate is disposed on the lower side as illustrated in FIG. 9, and a case where the electrode plate is disposed on the upper side as illustrated in FIG. 10.

As illustrated in the embodiments of FIGS. 9A and 10B, when the second electrode of the battery is a negative electrode, the electrode is not limited to a negative terminal exposed to the outside of the battery, but may also be in contact with a can formed inside an outer skin of the battery.

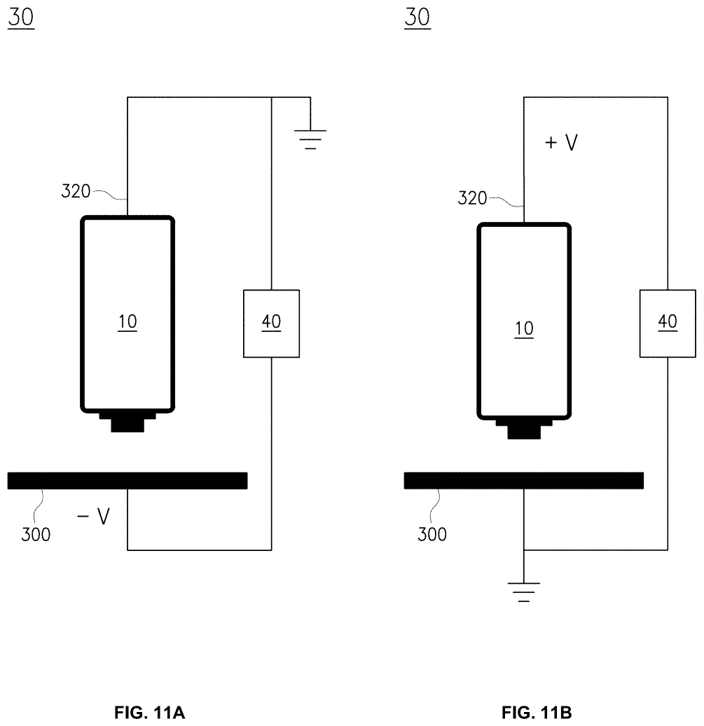

In the present disclosure, application of the electric field by the electric field appliers may be achieved in the following manner. That is, as illustrated in FIG. 11A, a negative voltage may be applied to the positive electrode of the battery while the negative electrode of the battery may be grounded. Alternatively, as illustrated in FIG. 11B, the positive electrode of the battery may be grounded while a positive voltage may be applied to the negative electrode of the battery.

Meanwhile, as illustrated in FIGS. 8 to 11, the battery according to the present disclosure may be formed in an upright or inverted state with respect to the ground.

The definition of the upright or inverted state is merely to describe an example of current use in which the battery is in the upright or inverted state, and the technical idea of the present disclosure is valid even when the battery is lying horizontally.

Additionally, in the embodiment of FIG. 11, there was conducted an experiment in which a power application direction of the electric field appliers 30 to the battery was such that the electric field appliers 30 apply a negative electric field to the positive electrode of the battery and apply a positive electric field to the negative electrode of the battery. However, the present disclosure is not necessarily limited thereto.

That is, in contrast to the case of the electric field application direction of FIG. 11, the electric field appliers 30 may ground the negative electrode of the battery and apply a positive voltage to the positive electrode of the battery, or may apply a negative voltage to the negative electrode of the battery and ground the positive electrode of the battery.

The battery fire extinguishing device according to the present disclosure configured as described above may prevent, delay, or extinguish a battery fire by applying an electric field to the battery 10 when there is a sign of a fire in the battery.

Additionally, as described above, it is preferable that one of the pair of electric field appliers 30 is grounded, the remaining one of the electric field appliers 30 is connected to the controller 50 that supplies the power supply 40, and the dielectric layer 20 is provided between each of the electric field appliers 30 and the battery 10 to ensure insulation between the electric field applier 30 and the battery 10.

According to the embodiment of the present disclosure, when a high voltage is applied through the electric field appliers 30, a dielectric layer (dielectric barrier) is provided, but when a low voltage is applied, the dielectric layer may not be provided.

As illustrated in FIG. 1, it is preferable that the battery fire extinguishing device according to the present disclosure further includes the controller 50 that receives a fire sign detection signal of the battery 10 and applies power to the electric field appliers 30.

That is, when the fire sign detection signal is transmitted from the controller 50 as the internal temperature of the battery 10 increases, the controller may determine that a fire has occurred, and apply power to the electric field appliers 30 to control unstable electric charges inside the battery and suppress collision of electric charges.

The controller 50 may convert battery discharge energy into power when there is a sign of a fire so that internal charge energy of the battery is consumed to generate an electric field.

Additionally, a sensor may be further provided to receive the fire sign detection signal from the battery 10. As the sensor, a device such as a heat sensor, an infrared sensor, or a pressure sensor may be used.

The battery 10 according to the present disclosure may have an electrode arrangement in which the electrodes are perpendicular to the ground, and the electric field appliers 30 may be formed as electrode plates formed above and below the battery 10.

Conventionally, when the temperature inside the battery 10 rises and thereby the electrolyte boils and reaches a predetermined pressure, venting occurs near the location where a safety venting device is installed (in the case of a cylindrical battery, it corresponds to the positive terminal), causing internal liquid, gas, and off-gas to be released.

In the present disclosure, the safety venting device of the battery 10 may be installed facing the ground, so when the safety venting device is activated when there is a sign of a fire in the battery, the internal electrolyte may be released by its own weight through the safety venting device.

That is, by using gravity to easily and quickly release the internal electrolyte, the internal electrolyte may be sufficiently released before damage to the separator occurs, thereby suppressing collision of electric charges and thus suppressing thermal runaway caused by an internal short circuit.

According to the known technology, in the case of a cylindrical battery 10, the safety venting device is formed on the positive electrode side. Therefore, in this case, the safety venting device of the battery 10 is installed facing the ground when the battery is in an inverted state.

Hereinafter, description will be made of an experiment for testing the battery fire extinguishing device by applying an electric field through the electric field appliers 30.

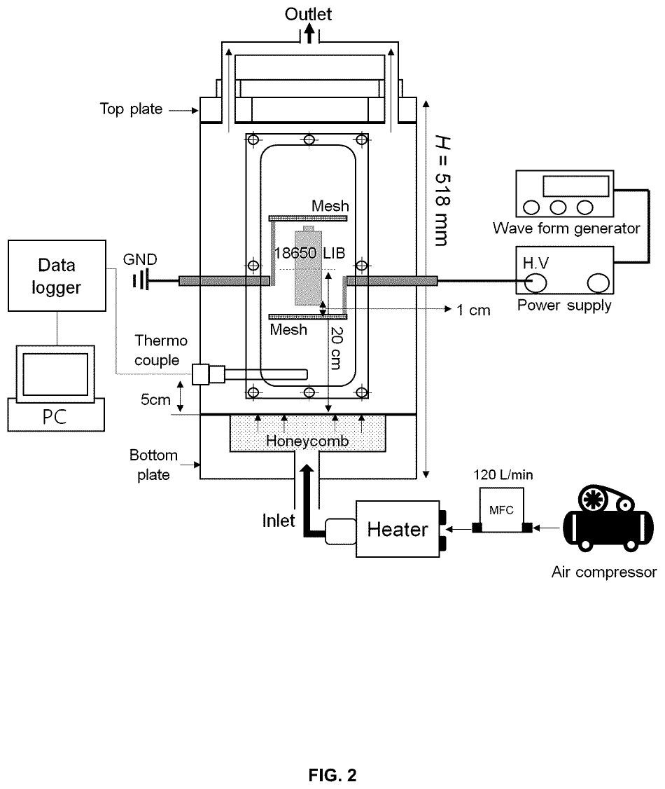

FIG. 2 is a schematic view illustrating an experiment for testing the battery fire extinguishing device using an electric field according to the present disclosure.

In order to conduct the experiment for testing the battery fire extinguishing device using the electric field, a ceramic honeycomb was installed at the bottom of a reactor to create a system in which high-temperature gas was supplied evenly. As the high-temperature gas, air and nitrogen were supplied according to experimental conditions. A battery was positioned at the center of the reactor, and electrodes for applying an electric field were installed in a mesh form at upper and lower portions of the battery.

An outlet was installed at the top of the reactor to smoothly release the high-temperature gas supplied from the bottom of the reactor, and the high-temperature gas was supplied into the reactor at a constant flow rate (120 L/min). A thermocouple was attached between the battery and the honeycomb inside the reactor to measure the internal temperature, and experimental data was stored through a data logger.

To apply an electric field, high voltage was supplied to the mesh electrodes through a waveform generator and a power supply, and a cylindrical lithium-ion battery (18650 LIB) was adopted as the battery.

The experiment for testing the battery fire extinguishing device using the electric field was performed in the following manner. High-temperature air was supplied into the reactor at a constant flow rate to raise the temperature inside the reactor.

Afterwards, when venting (electrolyte release) began at a positive terminal of the battery through a safety venting device, injection of high-temperature air was stopped, and an internal short circuit of the battery was induced to cause off-gas release and thermal runaway. Finally, whether thermal runaway occurred or not was observed depending on the presence or absence of an electric field.

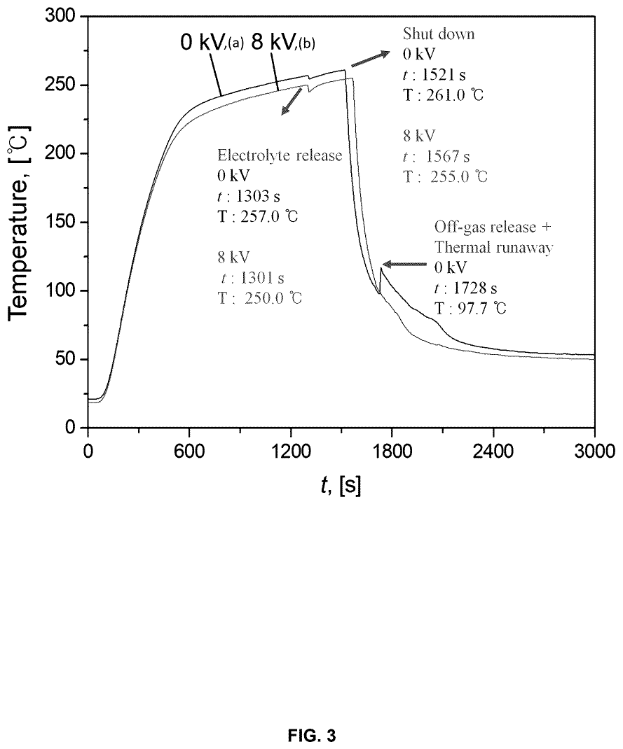

FIG. 3 is a graph illustrating whether thermal runaway occurs depending on the presence or absence of the electric field in the experiment of FIG. 2, and illustrates temperature distribution inside the reactor over time.

In FIG. 3, the experimental results for the battery without the electric field applied are represented by a solid line (a), and the experimental results for the battery supplied with +8 kV are represented by a solid line (b).

According to the results of the experiment for testing the battery fire extinguishing device using the electric field, in the case of the battery without the electric field applied, electrolyte release occurred at 1303 s, and the temperature inside the reactor at this time was 257° C.

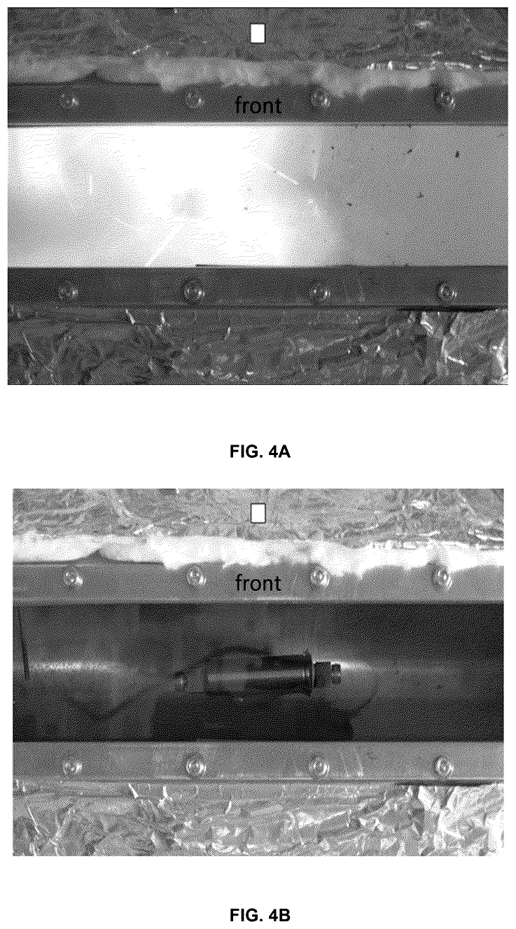

After about 4 minutes, the injection of high-temperature air was stopped and an internal short circuit was induced in the battery. As a result, as illustrated in FIG. 4A, off-gas release and thermal runaway occurred at 1728 s.

On the other hand, in the case of the battery with the electric field applied, electrolyte release occurred at 1301 s, and the temperature inside the reactor at this time was 250° C.

After about 4 minutes, the injection of high-temperature air was stopped and an internal short circuit was induced in the battery. As a result, as illustrated in FIG. 4B, no off-gas release or thermal runaway was observed.

Then, the temperature was raised again to 270° C., but since the electrolyte had already been released in a liquid state at the previous stage, off-gas release and thermal runaway due to high temperature were not observed.

That is, through the above experiment, it can be confirmed that off-gas release and thermal runaway do not occur in the battery with the electric field applied, unlike the battery without the electric field applied.

Hereinafter, an experiment for testing the battery fire extinguishing device based on oxidizer inhibition will be described.

To evaluate thermal runaway effect based on oxidizer inhibition in an external environment, which is one of the conventional technologies, only high-temperature nitrogen without an oxidizer was supplied (100 L/min) into a high-temperature reactor, and a high-temperature environment was continuously created without interruption of gas supply.

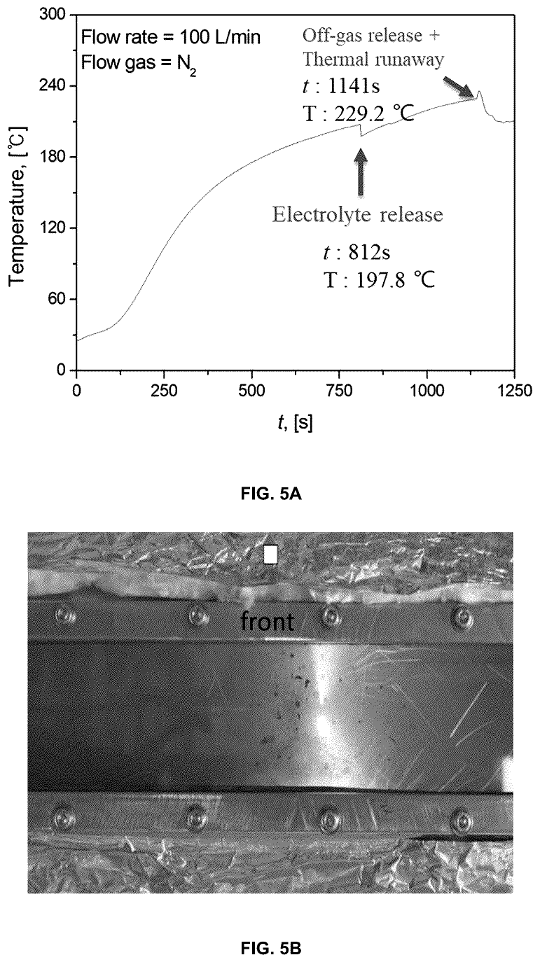

As a result, as illustrated in FIG. 5, thermal runaway occurred even in the absence of the oxidizer, and when an electric field was applied, thermal runaway was not observed even in an environment lacking the oxidizer.

That is, through the above experiment, it can be confirmed that off-gas release and thermal runaway do not occur in the battery with the electric field applied, regardless of whether the oxidizer is inhibited.

Hereinafter, an experiment for testing the battery fire extinguishing device depending on the position of the safety venting device will be described.

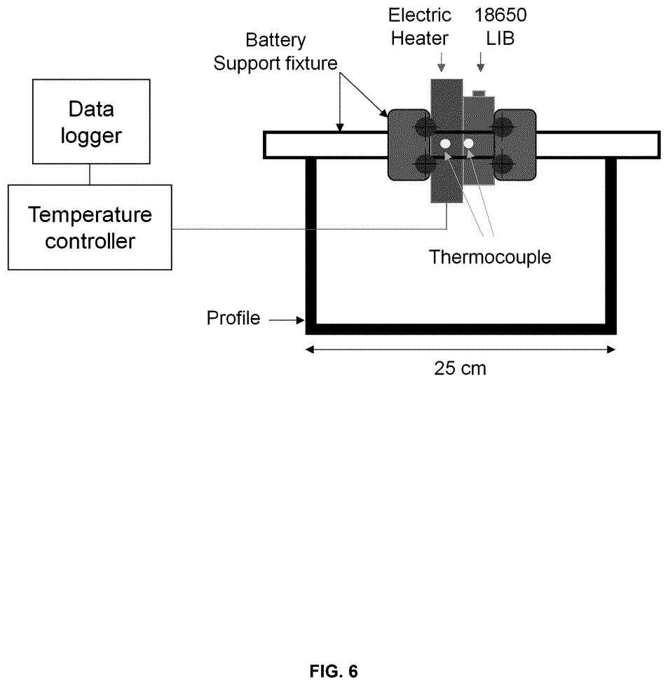

FIG. 6 is a schematic view illustrating a battery fire simulation experiment depending on the position of a safety venting device according to the present disclosure.

According to the lithium battery heating test standards of UL 1642 (standard for lithium batteries) (14) and KS C 8541, it is stipulated that there will be no ignition or explosion when a battery is heated from an initial temperature of 20±5° C. to 130° C. at a rate of 5±2° C./min and then the heating is maintained at 130° C. for 60 minutes.

In this experiment, in order to induce off-gas release and thermal runaway due to an internal short circuit in the battery, an electric heater was attached and fixed next to a battery, and a thermocouple was installed on the surfaces of an electric heater and the battery to measure the surface temperature. In order to evaluate whether thermal runaway occurred depending on the position of the safety venting device, the battery was installed so that a positive terminal faces upward and downward, respectively.

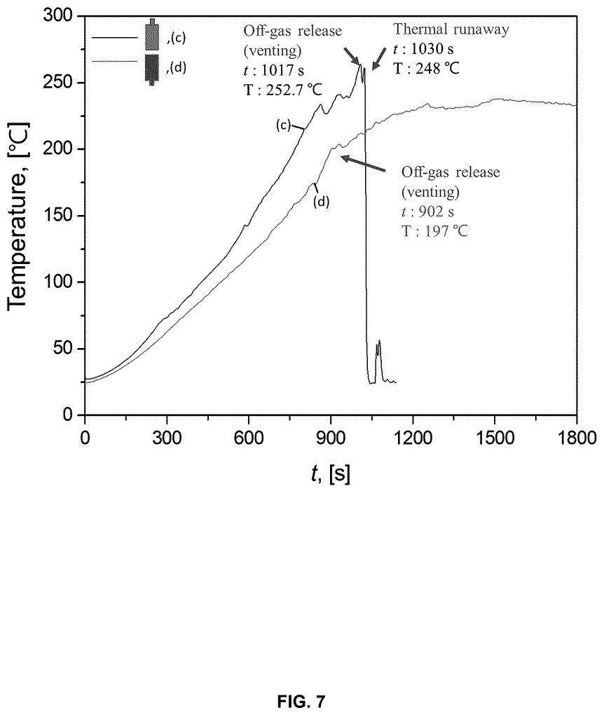

FIG. 7 is a graph illustrating whether thermal runaway occurs depending on the position of the safety venting device in the experiment of FIG. 6, and illustrates distribution of battery surface temperature over time.

The battery with the positive terminal facing upward is indicated by a solid line (c), and the battery with the positive terminal facing downward is indicated by a solid line (d).

First, in the case of the battery with the positive terminal facing upward, electrolyte release occurred at 1017 s, and the battery surface temperature at this time was 252.7° C.

After about 13 seconds, off-gas release and thermal runaway occurred at a battery surface temperature of 248° C.

On the other hand, in the case of the battery with the positive terminal facing downward, electrolyte release occurred at 902 s, and the battery surface temperature at this time was 197° C.

The temperature of the electric heater was continuously raised to induce a short circuit inside the battery, but off-gas release and thermal runaway did not occur since most of the liquid electrolyte inside the battery has been released downward.

That is, through the above experiment, it can be confirmed that off-gas release and thermal runaway do not occur in the battery with the positive terminal facing downward (the ground).

The above experiment is based on the case where the safety venting device of the cylindrical battery is installed at the positive terminal. Even in the case of a pouch type, etc., the same effect will be achieved when the safety venting device is installed facing the ground.

Hereinafter, the effects of the present disclosure will be described.

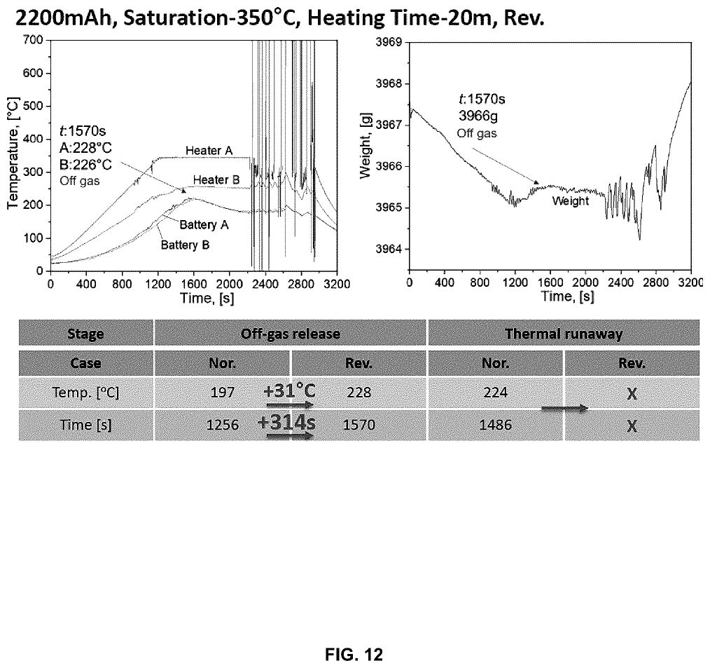

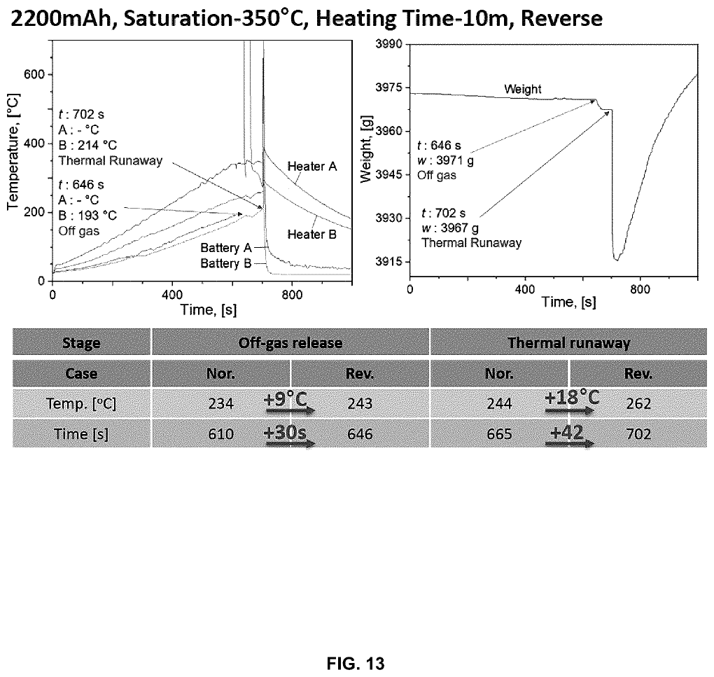

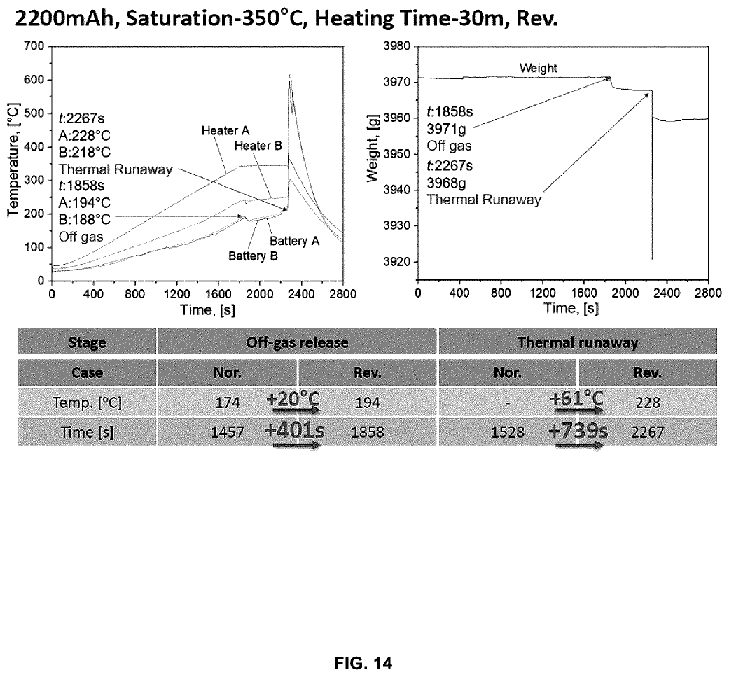

FIGS. 12 to 14 are graphs illustrating the results of experiments conducted under the following conditions: battery capacity—2200 mAh, saturation—350° C. heat source, and upright and inverted states.

As illustrated in FIGS. 12 to 14, the experiment results commonly show that the off-gas generation time in the inverted state was significantly shorter than in the upright state, and thermal runaway occurred in the upright state while thermal runaway was blocked in the inverted state.

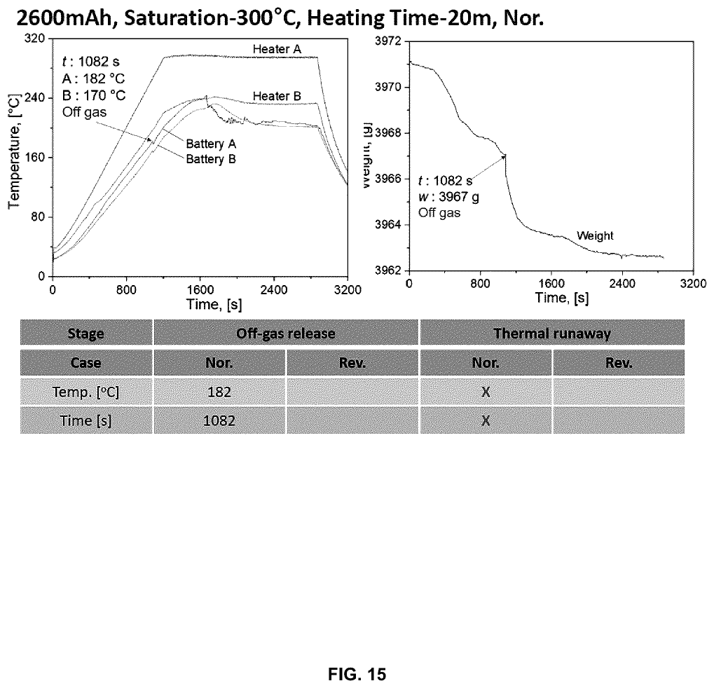

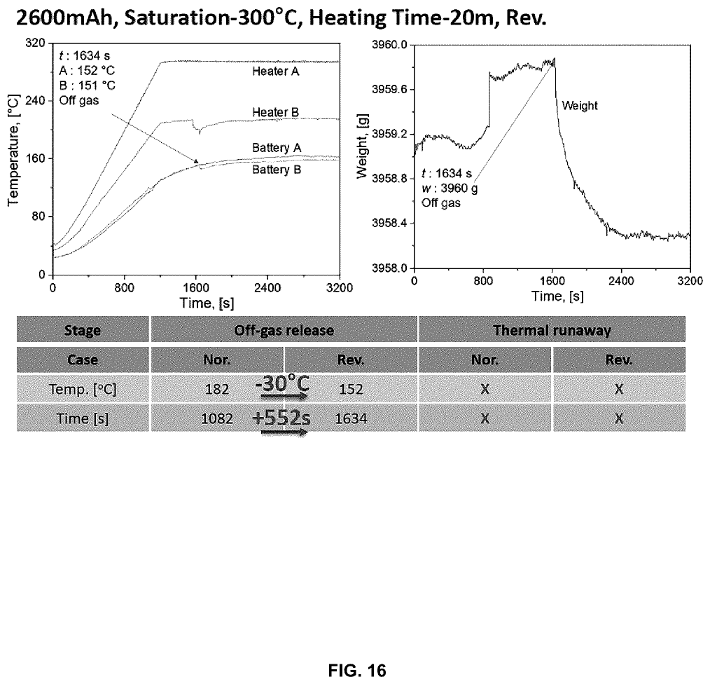

FIGS. 15 and 16 are graphs illustrating the results of experiments conducted under the following conditions: battery capacity—2600 mAh, saturation—300° C. heat source, heating time—20 m, and upright and inverted states.

In FIGS. 15 and 16, the experiment results commonly show that the off-gas generation time in the inverted state was significantly shorter than in the upright state, and thermal runaway was blocked in both the upright and inverted states.

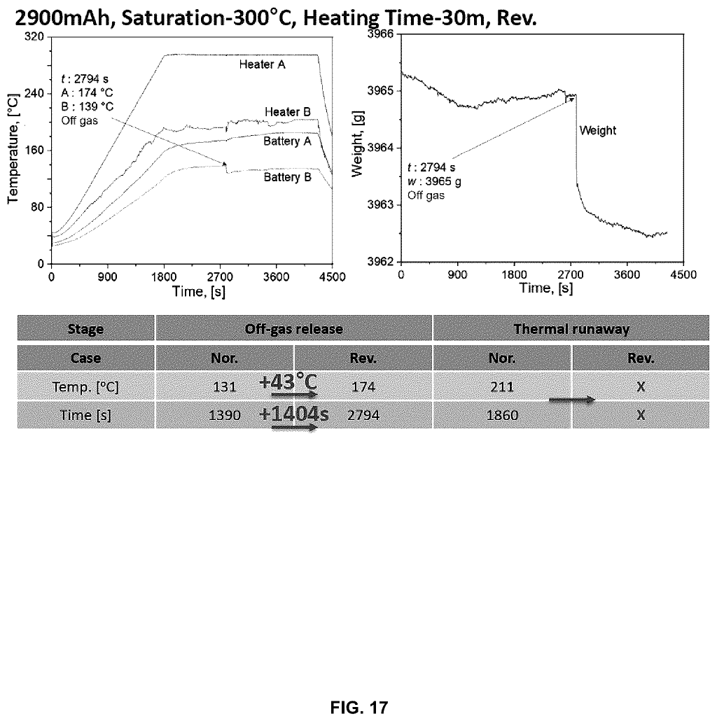

FIG. 17 illustrates graphs illustrating the results of an experiment conducted under the following conditions: battery capacity—2900 mAh, saturation—300° C. heat source, heating time—30 m, and upright and inverted states.

In these modified conditions, it can be shown that the off-gas generation time in the inverted state was significantly shorter than in the upright state, and thermal runaway occurred in the upright state while thermal runaway was blocked in the inverted state.

As demonstrated from the above-described experiments of the present disclosure, applying the electric field when the battery generates heat may delay the time of battery off-gas generation and block thermal runaway, greatly helping to extinguish a battery fire.

The accompanying drawings are provided to illustrate one specific embodiment of the present disclosure, and combinations of various forms illustrated in the drawings are possible in order to realize the gist of the present disclosure.

Therefore, the present disclosure is not limited to the above-described embodiments, and those skilled in the art will appreciate that various modifications are possible without departing from the scope and spirit of the present disclosure as disclosed in the accompanying claims.

What is claimed is:

1. A battery fire extinguishing device, comprising:
a battery; and
a pair of electric field appliers formed on opposite electrodes of the battery and applying an electric field to the battery when there is a sign of a fire in the battery,
wherein when there is the sign of the fire in the battery, the battery fire extinguishing device prevents, delays, or extinguishes the fire by applying the electric field to the battery.

2. The battery fire extinguishing device of claim 1, wherein the pair of electric field appliers comprise a pair of electrode plates formed on the opposite electrodes of the battery.

3. The battery fire extinguishing device of claim 1, wherein the pair of electric field appliers comprise:
an electrode plate formed on a first electrode of the battery; and
an electrode in contact with a second electrode of the battery.

4. The battery fire extinguishing device of claim 3, wherein when the second electrode of the above battery is a negative electrode,
the electrode is an electrode that is in contact a battery can.

5. The battery fire extinguishing device of claim 1, wherein the pair of electric field appliers ground a positive electrode of the battery and apply a positive voltage to a negative electrode of the battery.

6. The battery fire extinguishing device of claim 1, wherein the pair of electric field appliers apply a negative voltage to a positive electrode of the battery and ground a negative electrode of the battery.

7. The battery fire extinguishing device of claim 1, wherein the pair of electric field appliers ground a negative electrode of the battery and apply a positive voltage to a positive electrode of the battery.

8. The battery fire extinguishing device of claim 1, wherein the pair of electric field appliers apply a negative voltage to a negative electrode of the battery and ground a positive electrode of the battery.

9. The battery fire extinguishing device of claim 1, wherein the battery is in an upright or inverted state with respect to a ground.

10. The battery fire extinguishing device of claim 1, further comprising:
a controller that receives a fire sign detection signal of the battery and applies power to the pair of electric field appliers.

11. The battery fire extinguishing device of claim 1, wherein the controller converts battery discharge energy into power for the electric field when there is the sign of the fire so that internal charge energy of the battery is consumed to generate the electric field.

12. The battery fire extinguishing device of claim 1, wherein the battery is installed with a safety venting device facing a ground so that when the safety venting device is activated when there is the sign of the battery fire, an internal electrolyte is released by its own weight through the safety venting device.

13. The battery fire extinguishing device of claim 1, wherein a dielectric layer is provided between each of the pair of electric field appliers and the battery.
